(19) United States
(12) Patent Application Publication
(10) Pub. No.: US 2008/0088122 A1
(43) Pub. Date: Apr. 17, 2008

(54) Zipper Book With Handle

(76) Inventors: Ashley C. Andersen, Fairfield, CT (US); Laura Galvin, Middletown, RI (US)

Correspondence Address: ST. ONGE STEWARD JOHNSTON & REENS LLC, 986 Bedford Street, Stamford, CT, 06905-5619, US

(21) Appl. No.: 11/866,183

(22) Filed: Oct. 2, 2007

Related U.S. Application Data
(60) Provisional application No. 60/848,827, filed on Oct. 2, 2006.

(51) Int. Cl. B42D 3/10; B42D 3/12

(52) U.S. Cl. 281/31

(57) ABSTRACT

A book assembly including a first cover and a second cover, each cover including at least one paperboard layer and at least one padded layer, a spine, a plurality of pages hinged to the spine, a handle attached to the spine, at least one media storage assembly attached to at least one of the first and second covers, and a zipper for securing the first cover to the second cover and enclosing each of the pages and media storage assembly.

### CROSS-REFERENCE TO RELATED APPLICATIONS

This application claims the benefit of, under 35 U.S.C. 119(e), U.S. Provisional Patent Application No. 60/848,827, filed Oct. 2, 2006, which application is hereby incorporated by reference herein.

### FIELD OF THE INVENTION

The invention relates to books such as children's books, and more specifically to a zipper book with a handle and media storage assembly.

### BACKGROUND OF THE INVENTION

For many years, books have been supplied to the public along with prerecorded material associated with the book. For example, books have been provided in packaging that also includes audio tapes related to the book. These have proved to be a source of great enjoyment to many and a valuable teaching aid to children.

However, with the advent of newer technologies, the use of storage medium such as Compact Disks, DVDs and other optical and digital storage devices have become favored over the use of tapes as a storage medium because of their high storage capabilities, their small size and thin profile, and their long storage life. As such, more and more books are being sold in conjunction with a CD or DVD, either individually packaged or packaged within the book. For example, the applicant's co-pending U.S. Patent Application Publication No. 2004/0188,283 describes an advantageous book with a CD holder in the book's cover. However, there is a desire in the art for improved assemblies of books and digital media.

Furthermore, children's books are generally sold without handles or other means to permit easy carrying of the book by children with small hands. There is a desire in the art for a means for users, particularly children, to securely carry a book and its corresponding digital media. There is also a need to supply books with closures that protect the pages and other contents, such as digital media, from damage and wear.

### SUMMARY OF THE INVENTION

Accordingly, it is an object of the present invention to provide a book including an internal digital media holder and a zippered opening for securing the digital media and pages of the book. It is a further object to provide a book with a zippered opening and a handle for carrying the book.

These and other objectives are achieved by providing a book assembly including a first cover including a media storage holder, a second cover, a spine hingedly connected to at least one edge of each of the first cover and the second cover, a handle extending from an outer face of the spine, a plurality of pages attached to an inner face of the spine, a zipper attached to at least a portion of the second cover and at least a portion of the second cover, and wherein the zipper removeably secures the first cover to the second cover and encloses each of the pages and the media storage holder. In some embodiments, each of the first cover and the second cover includes an outside layer and an inside layer, and the zipper is sewn between the outside layers and the inside layers of each.

Further provide is a book assembly including a first cover and a second cover, each cover including at least one paperboard layer and at least one padded layer, a spine, a plurality of pages hinged to the spine, a handle attached to the spine, at least one media storage assembly attached to at least one of the first and second covers, and a zipper for securing the first cover to the second cover and enclosing each of the pages and media storage assembly.

Other objectives of the present invention are achieved by providing a book assembly including a cover including at least one paperboard layer and at least one padded layer, the cover having a front portion, a spine portion, and a back portion, a plurality of pages hinged to the spine portion, a handle attached to the spine portion, at least one media storage assembly attached to the cover, a zipper for securing the front portion to the back portion and enclosing each of the pages and the media storage assembly, wherein each of the front portion, the back portion, and the pages includes a substantially round outer edge, and wherein the zipper is secured about the round outer edge of each of the front portion and the back portion of the cover.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 illustrates a zipper book with a handle according to an exemplary embodiment of the present invention.

FIG. 2 illustrates an outside view of the zipper book shown in FIG. 1.

FIG. 3 illustrates an inside view of the zipper book shown in FIG. 1.

FIG. 4A illustrates an end view of the zipper book shown in FIG. 1.

FIG. 4B illustrates another end view of the zipper book shown in FIG. 1.

### DETAILED DESCRIPTION OF THE INVENTION

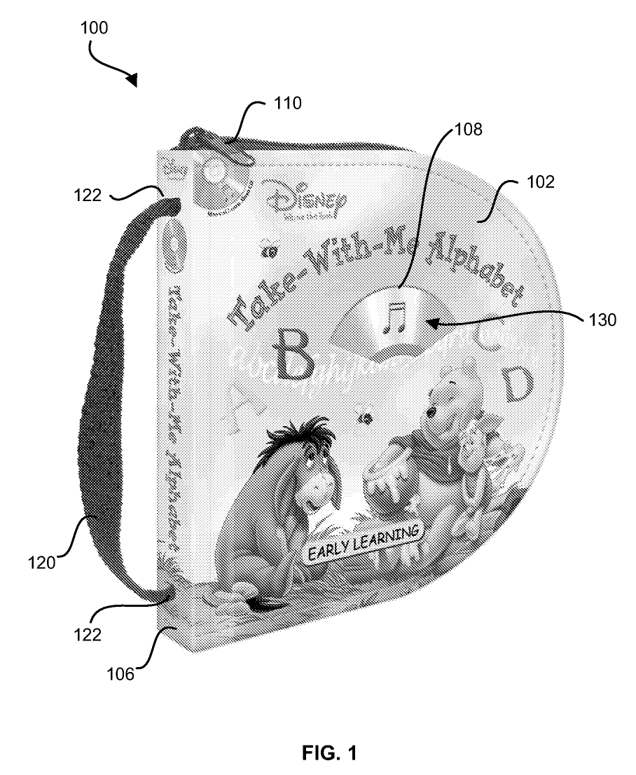

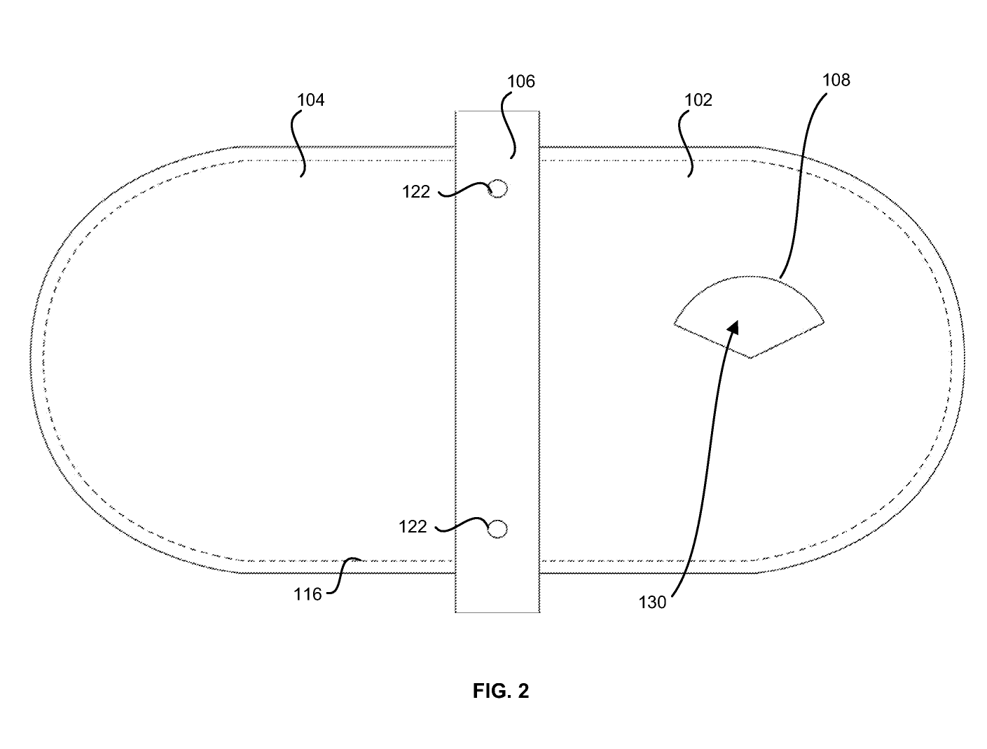

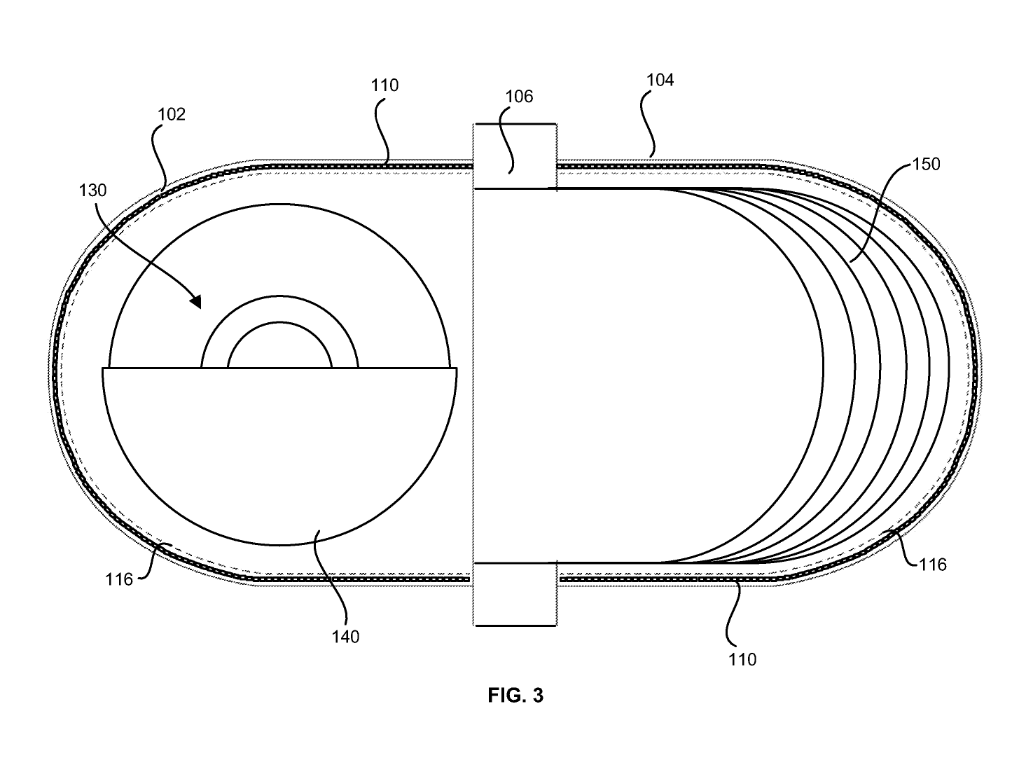

The invention disclosed herein contemplates an apparatus and method for assembling a book with a zippered cover and a media storage assembly. An exemplary embodiment of the invention is illustrated in the FIGS. 1-3.

The book 100 includes a front cover 102 and a back cover 104. The covers in the exemplary embodiment are substantially circular and have a diameter of approximately six (6) inches. In some embodiments, the covers 102/104 are rectangular with rounded corners. Each of the covers includes an interior layer, such as two (2) millimeter paperboard. Each cover further includes a padded layer. For example, the front cover 102 and back cover 104 may include a foam-padded layer over the interior layer. At least one of the covers may include a cut-out or window 108, e.g., a die-cut window, for displaying a portion of a media storage device 130 enclosed in the book 100.

The book 100 also includes a spine 106 or binding. In some embodiments, the front cover 102, spine 106 and back cover 104 are comprised in one continuous wrap around cover. The spine width may vary depending on the number of pages of the book, but is preferably up to one (1) inch. The book 100 further includes a handle 120 anchored or hinged to the spine 106. The handle 120 may be any desired shape or size. The handle 120 may be, for example, a fabric handle or a rigid plastic handle. In preferred embodiments, the handle is a flexible and soft fabric to prevent pinching of fingers between a rigid handle and the book's spine. In some embodiments, the handle 120 is anchored via two holes 122 in the spine 106 or outer layer of the spine. For example, a fabric handle 120 may extend through the holes 122 and be secured with a knot or other means inside, or inboard of, the spine 106.

Inside the book 100 is any number of pages 150. For example, the book 100 may include 20 to 24 thin paperboard pages having a substantially circular or rounded outer edge. In some embodiments, the pages are rectangular with rounded corners. The pages 150 preferably display a story both in words and graphically. Each of the pages 150 are substantially the same size and extend to or inboard of the zipper 110. The book 100 may further include a media storage assembly 140 for housing a media storage device 130. In some embodiments, the media storage assembly 140 includes a paperboard pouch having a plurality of tabs. The tabs are inserted into slots on an inside layer of the cover 102 or 104 during assembly of the book 100. The media storage assembly 140 may also be adhered to an inside layer with adhesive. In some embodiments, the media storage assembly 140 is a plastic clamshell blister.

The media storage device 130 may be, for example, a CD, a CD-ROM, or a DVD. The media storage device 130 may include any media, such as music related to the story, an interactive CD-ROM media, a digital game or learning exercise, and/or a DVD film of, or related to, the story depicted in the pages 150.

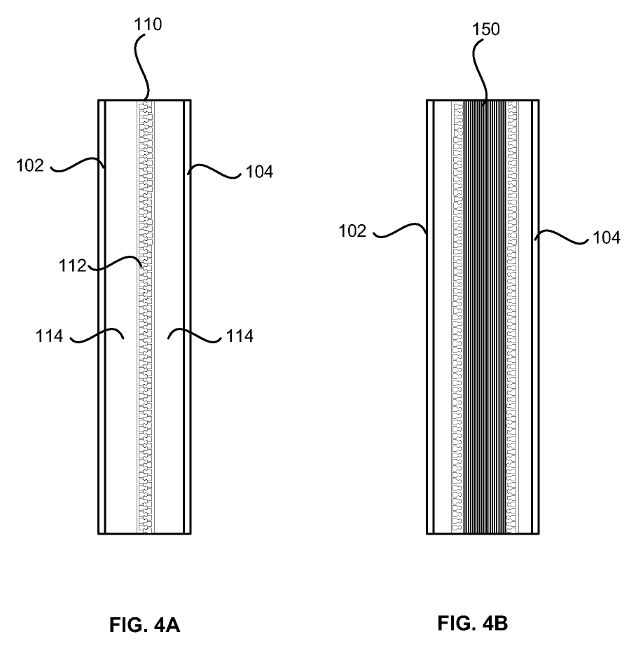

As shown in FIGS. 4A-4B, the book 100 further includes a zipper 110. The zipper 110 includes a plurality of teeth 112 and fabric tape portions 114. The zipper 110 is bound to both the front and back covers 102/104. The zipper 110 preferably extends from one end of the spine 106 (e.g., bottom) around each of the covers 102/104, and to the other end of the spine 106 (e.g., top), or vice versa.

The tape portion 114 of the zipper 110 is sewn down between layers making up inside and outside portions of each of the covers 102/104. In some embodiments, the zipper 110 is sewn between paperboard layers of the covers 102/104. In preferred embodiments, a single line of continuous and/or uninterrupted stitching 116 is used to assemble the covers 102/104 and secure the zipper 110 to each. In other preferred embodiments, a continuous line of stitching 116 is used to assemble the front cover 102 and secure the zipper 110 to the front cover 102, and a second continuous line of stitching 116 is similarly used on the back cover 104. This means of assembly provides for lower manufacturing costs.

The zipper 110 encloses the pages 150, the media storage assembly 140 and media storage device 130. The width of the zipper 110 is therefore approximately equal to the width of all of the pages 150 and/or the pages and media storage device 130. Furthermore, other contents may be added to or otherwise enclosed in the book. As such, the book 100 is easily transportable, e.g., by a child, with its pages 150 and other contents secure. The zipper 110 prevents the pages from flapping while the book is carried, prevents the CD or DVD from being lost, and provides a fun for children to open and close the book 100. The pages 150 and media storage device 130 are also protected from breakage and/or wear by the enclosed padded covers 102/104.

Although the invention has been described with reference to a particular arrangement of parts, features and the like, these are not intended to exhaust all possible arrangements or features, and indeed many modifications and variations will be ascertainable to those of skill in the art.

What is claimed is:

1. A book assembly, comprising:
a first cover comprising a media storage holder;
a second cover;
a spine hingedly connected to at least one edge of each of said first cover and said second cover;
a handle extending from an outer face of said spine;
a plurality of pages attached to an inner face of said spine;
a zipper attached to at least a portion of said second cover and at least a portion of said second cover; and
wherein said zipper removeably secures said first cover to said second cover and encloses each of said pages and the media storage holder.

2. The book assembly according to claim 1, wherein said zipper extends from a first end of said spine to a second end of said spine.

3. The book assembly according to claim 1,
wherein each of said first cover and said second cover includes an outside layer and an inside layer; and
wherein said zipper is sewn between the outside layer and the inside layer of each of said first cover and said second cover.

4. The book assembly according to claim 3, wherein each of said first cover and said second cover includes a padded layer between the outside layer and the inside layer.

5. The book assembly according to claim 3, wherein each of said first cover and said second cover includes a continuous line of stitching securing the outside layer, the inside layer and the zipper.

6. The book assembly according to claim 3, wherein the media storage assembly comprises a paperboard pouch attached to the inside layer of said first cover.

7. The book assembly according to claim 1, wherein zipper has a width substantially equal to a width of the plurality of pages.

8. The book assembly according to claim 1, wherein the first cover includes a window for displaying a portion of a media storage device in the media storage holder.

9. The book assembly according to claim 1, further comprising:
a continuous cover piece covering said first cover, said second cover, and said spine.

10. The book assembly according to claim 1, wherein the media storage holder includes at least one of a CD, a CD-ROM and a DVD.

11. The book assembly according to claim 1, wherein said plurality of pages includes two or more paper board pages.

12. The book assembly according to claim 1, wherein each of said first cover, said second cover, and said pages includes at least one substantially round outer edge.

13. A book assembly, comprising:
a first cover and a second cover, each cover including at least one paperboard layer and at least one padded layer;
a spine;
a plurality of pages hinged to said spine;
a handle attached to said spine;
at least one media storage assembly attached to at least one of the first and second covers; and
a zipper for securing said first cover to said second cover and enclosing each of the pages and media storage assembly.

14. The book assembly according to claim 13, wherein said zipper extends from a first end of said spine to a second end of said spine.

15. The book according to claim 13, wherein each of said first cover and said second cover includes a continuous line of stitching securing the zipper to the at least one paperboard layer and the at least one padded layer.

16. The book assembly according to claim 13, wherein said media storage assembly includes a paperboard pouch attached to at least one paper board layer of said first cover.

17. The book assembly according to claim 13, wherein the first cover includes a window for displaying a portion of a media storage device in the media storage holder.

18. The book assembly according to claim 13, further comprising:
a continuous cover piece covering said first cover, said second cover, and said spine.

19. A book assembly, comprising:
a cover including at least one paperboard layer and at least one padded layer, said cover having a front portion, a spine portion, and a back portion;
a plurality of pages hinged to said spine portion;
a handle attached to said spine portion;
at least one media storage assembly attached to said cover;
a zipper for securing said front portion to said back portion and enclosing each of said pages and said media storage assembly;
wherein each of the front portion, the back portion, and said pages includes a substantially round outer edge; and
wherein said zipper is secured about the round outer edge of each of the front portion and the back portion of said cover.

20. The book assembly according to claim 19, wherein said cover includes window for displaying a portion of a media storage device in said media storage holder.
